(19) United States
(12) Patent Application Publication
(10) Pub. No.: US 2011/0270952 A1
(43) Pub. Date: Nov. 3, 2011

(54) COMPUTER IN A DONGLE

(76) Inventors: Guy RAY, Beit Nir (IL); Dudu Avital, Tel-Aviv (IL)

(21) Appl. No.: 13/090,831

(22) Filed: Apr. 20, 2011

Related U.S. Application Data
(60) Provisional application No. 61/329,895, filed on Apr. 30, 2010.

(51) Int. Cl. G06F 15/16

(52) U.S. Cl. 709/218; 709/217

(57) ABSTRACT

Aspects of the disclosure provide a dongle device for providing services at a network device, such as a gateway device. The dongle device includes a connector configured to connect the dongle device to a network device that performs packet switching in and out of a network and/or within the network. The connector has a power pin configured to receive a power supply from the network device to power up the dongle device, and a data pin configured to enable the dongle device to communicate with the network device. The dongle device further includes a processor configured to provide a service in the network after the dongle device is powered up.

### INCORPORATION BY REFERENCE

This application claims the benefit of U.S. Provisional Application No. 61/329,895, “Computer in a Dangle” filed on Apr. 30, 2010, which is incorporated herein by reference in its entirety.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A dongle device adds additional resources to a host device. Some home network devices suffer from limited packet handling capabilities, for example, due to small processors and/or insufficient memory.

### SUMMARY

Aspects of the disclosure provide a dongle device for providing services at a network device, such as a gateway device, and the like. The dongle device includes a connector configured to connect the dongle device to a network device that performs packet switching in and out of a network and/or within the network. The connector has a power pin configured to receive a power supply from the network device to power up the dongle device, and a data pin configured to enable the dongle device to communicate with the network device. The dongle device further includes a processor configured to provide a service in the network after the dongle device is powered up. In an embodiment, the dongle device includes a memory configured to store at least instruction codes of the service. In another embodiment, the processor is hard coded with the service. In an example, the dongle device includes a wireless transceiver configured to receive and transmit wireless signals.

In an embodiment, the processor of the dongle device executes a suitable procedure to obtain an independent Internet protocol (IP) address, thus the dongle device operates as an independent node in the network.

According to an aspect of the disclosure, the network device is a residential gateway device that couples a local area network (LAN) to another network. The connector is configured to connect the dongle device to the residential gateway device, and the processor is configured to provide the service to the LAN. In an example, the processor is configured to execute instruction codes of the service, and provide the service to the LAN. In other example, the processor is hard coded with the service and is configured to operate and provide the service to the LAN.

In an example, the connector is configured according to at least one of a universal serial bus (USB) standard and an IEEE 1394 standard.

In an example, the dongle device includes a single chip that integrates the memory and the processor. In another example, the dongle device includes a memory chip that includes the memory, and a system-on-chip that includes the processor.

It is noted that the processor can provide various services, such as a cloud backup service, an antivirus service, an internet accelerator service, a JAVA application service, a home automation service, a voice-over-internet-protocol (VOIP) service, a network attached storage (NAS) service, an intrusion detection service, a package processing service, and the like.

Aspects of the disclosure provide an electronic system. The electronic system includes a network device configured to perform packet switching in and out of a network and/or within the network, and a dongle device coupled to the network device to provide services in the network. In an example, the network device is a gateway device, and the dongle device provides the service at the gateway platform. The dongle device includes a connector configured to connect the dongle device to the network device. The connector has a power pin configured to receive a power supply from the network device to power up the dangle device, and a data pin configured to enable the dongle device to communicate with the network device. The dongle device further includes a processor configured to provide a service in the network after the dongle device is powered up. In an embodiment, the dongle device includes a memory configured to store instruction codes of the service. In another embodiment, the processor is hard coded to operate and provide the service. In an example, the dongle device includes a wireless transceiver configured to receive and transmit wireless signals.

Aspects of the disclosure provide a method for upgrading a network device. The method includes coupling a dongle device including a packet processor and a memory to a port of the network device, and processing packets received at the network device using the dongle device.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of a network system example 100 according to an embodiment of the disclosure;

FIG. 2 shows a block diagram of an integrated circuit (IC) chip example 200 according to an embodiment of the disclosure; and

FIG. 3 shows a flowchart outlining a process example 300 for using a dongle device according to an embodiment of the disclosure.

### DETAILED DESCRIPTION OF EMBODIMENTS

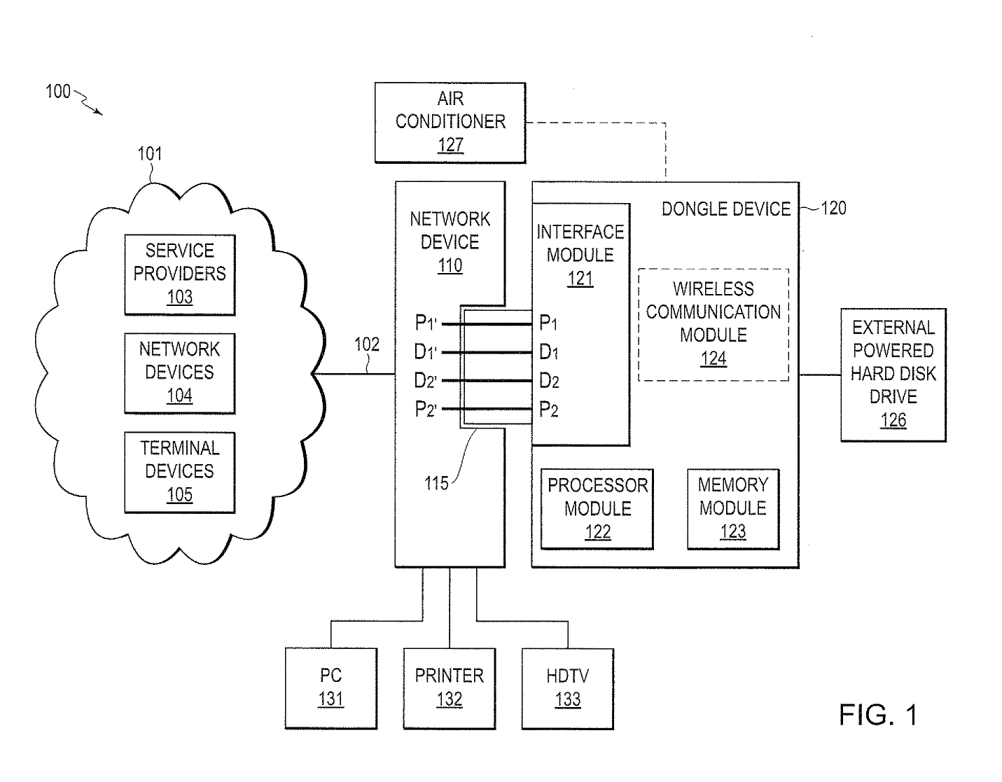

FIG. 1 shows a block diagram of a network system example 100 according to an embodiment of the disclosure. The network system 100 includes a network 101, a network device 110 that is powered up and coupled to the network 101, and a dongle device 120 that is plugged in a port of the network device 110. These elements are coupled together as shown in FIG. 1.

The network 101 includes a single network or a plurality of networks of the same or different types. In an example, the network 101 includes a fiber optic network in connection with a cellular network. In another example, the network 101 includes a local telephone network in connection with a long distance telephone network. Further, the network 101 can be a data network or a telecommunications or video distribution (e.g., cable, terrestrial broadcast, or satellite) network in connection with a data network. Any combination of telecommunications, video/audio distribution and data networks, whether a global, national, regional, wide-area, local area, or in-home network, can be used without departing from the spirit and scope of the disclosure.

The network 101 includes devices of various types. For example, the network 101 includes service providers 103, such as Internet service provider, data storage service provider, phone service provider, mobile service provider, and the like. Further, the network 101 includes network devices 104, such as routers, network switches, access points, gateway devices, and the like. In addition, the network 101 includes terminal devices 105, such as servers, cell phones, personal commuters, handheld devices, and the like.

The network device 110 can be any suitable networking device that couples terminal devices or other network devices with the network 101. In an example, the network device 110 is a residential gateway device that couples a home local area network (LAN) or a corporate LAN to Internet or other wide area network (WAN). In an example, the network device 110 is a cable modem, a network switch, a consumer-grade router, a wireless access point, a set-top box, and the like. In another example, the network device 110 is a device combining functions of two or more of a cable modem, a network switch, a consumer-grade router, a wireless access point, a set-top box, and the like.

Generally, the network device 110 is an always-on device. For example, a power plug of the network device 110 is plugged into a power receptacle on the wall at all times. In addition, in an example, the network device 110 is configured to have simple and stable hardware and software, such that the networking operations of the network device 110 are stable and reliable. In another example, a network provider provides the network device 110 to a subscriber for a specific networking service. The network device 110 has simple hardware for a reduced cost, and has preloaded software that the user is prohibited from changing.

In an embodiment, the network device 110 includes suitable wired or wireless interfaces, such as Ethernet, universal serial bus (USB), IEEE 1394, high definition multimedia interface (HDMI), Wi-Fi, Bluetooth, and the like, to couple various terminal devices and network devices. In an embodiment, the various terminal devices and the network devices are home networking devices, such as a personal computer (PC) 131, a printer 132, a high definition television (HDTV) 133, and the like. The various terminal and network devices form a LAN, and the network device 110 is a residential gateway that couples the LAN to the network 101. In an example, the network device 110 includes an Ethernet interface that couples the PC 131 with the network device 110. The Ethernet interface includes suitable software component (e.g., instruction codes), electronic circuit component (e.g., physical layer), and mechanical component (e.g., connector) that are configured according to the Ethernet standard. In another example, the network device 110 includes an HDMI interface that couples the HDTV 133 with the network device 110. The HDMI interface includes suitable software component, electronic circuit component, and mechanical component that are configured according to the HDMI standard.

The dongle device 120 is coupled to the network device 110 and provides additional services to the network system 100. In an embodiment, a user wants a new service in the LAN. In an example, the new service is desired to be an always-on service, such as a voice over Internet protocol (VOIP) phone service, a cloud backup service, and the like. It's noted that the new service can be a temporary service that is not always-on. In another example, the new service is desired to be at a gateway platform of the LAN, such as a movie rental service, a download portal service, and the like.

In an embodiment, the hardware of the network device 110 is simple, and has insufficient processing power such that it is incapable of supporting various emerging services—as discussed above. In addition, in an embodiment, a consumer may be prohibited by an internet service provider from changing the software of the network device 110. The dongle device 120 is configured to have additional processing power for the new service, and to store software for the new service. In an embodiment, the processor and software installed on the dongle are pre-debugged and approved by the ISP (or other entity that provides the network device to the internet). When the dongle device 120 is plugged in the network device 110, the network device 110 powers up the dongle device 120. The dongle device 120 uses the additional processing power to execute the software for the new service, and then provides the new service at the gateway platform. Thus, the network device 110 is upgraded.

In an embodiment, the dongle device 120 includes an interface module 121, a processor module 122 and a memory module 123. The memory module 123 stores instruction codes, the processor module 122 executes the instruction codes, and the interface module 121 receives a power supply from the network device 110, and communicates with the network device 110. In some embodiments, the processor module 122 includes, instead of or in addition to a software driven processor, a dedicated hard coded hardware processor as well for processing network packets.

The interface module 121 includes suitable software component, electronic circuit component and mechanical component that are configured to couple the dongle device 120 with the network device 110. It is noted that the interface module 121 can be configured according to any suitable standard. In an example, the interface module 121 includes software component, electronic circuit component, and mechanical component that are configured according to a USB standard. In another example, the interface module 121 includes software component, electronic circuit component, and mechanical component that are configured according to an IEEE 1394 standard.

In the FIG. 1 example, the interface module 121 includes a mechanical connector 125 that can be plugged in a host connector 115 of the network device 110. The mechanical connector 125 includes power pins P1-P2, and data pins D1-D2. The host connector 115 includes power pins P1′-P2′ and data pins D1′-D2′. When the mechanical connector 125 is plugged in the host connector 115, the power pins P1-P2 are respectively coupled to the power pins P1′-P2′, and the data pins D1-D2 are respectively coupled to the data pins D1′-D2′. Via the coupled power pins, the network device 110 provides power to power up the dongle device 120. Via the coupled data pins, the dongle device 120 transmits signals to the network device 110 and receives signals from the network device 110.

The memory module 123 stores instruction codes of one or more services. In an example, the memory module 123 is pre-loaded with the instruction codes. For example, a service provider pre-loads the instruction codes of a service in the dongle device 120 and sells the dongle device 120 with the pre-loaded instruction codes. In another example, the memory module 123 is loaded with the instruction codes after the dongle device 120 is coupled with the network device 110. For example, the PC 131 transmits the instruction codes to store in the dongle device 120 via the network device 110 or the PC 131 updates the instruction codes already stored in the dongle device 120. In another example, the memory module 123 performs other functions, such as storing packets during processing.

The processor module 122 is configured to provide the service in the network system 100. In an embodiment, the dongle device 110 is configured in a plug-and-play mode, such that the processor module 122 automatically operates to provide the service. In an example, when the mechanical connector 125 is plugged in the host connector 115, the power pins P1-P2 receives power supply, and suitably directs the power supply to power up the processor module 122. When the processor module 122 is powered up, the processor module 122 resets to a predetermined start state. From the start state, the processor module 122 executes instruction codes of a routine procedure to initialize the dongle device 120. Then, the processor module 122 executes instruction codes of the service.

In an embodiment, the dongle device 120 is configured as a reduced computer that has reduced size and reduced cost, but is able to execute instruction codes. In an example, the electronic components of the interface module 121, the processor module 122, and the memory module 123 are integrated on a single chip. The chip is suitably designed to have a power consumption that is lower than a power limit defined in a standard, such as a USB standard. Then, when the mechanical connector 125 is plugged in the host connector 115, the power supply from the power pins P1-P2 is sufficient for power up the chip. Thus, the dongle device 120 does not need separate power module or network module, and has reduced size and reduced cost.

It is noted that, in another example, the electronic components of the interface module 121, the processor module 122 and the memory module 123 are integrated on a chipset that has multiple chips. The multiple chips are suitably coupled together. For example, the chipset includes a first chip that integrates the memory module 123 and a second chip that integrates the electronic components of the interface module 121 and the processor module 122. The chipset is suitably designed to have a power consumption that is lower than the power limit defined in a standard, such as the USB standard. Then, similar to the single chip example, the dongle device 120 does not need separate power module or network module, and has reduced size and reduced cost.

In another embodiment, the dongle device 120 is configured as an always-on computer to provide service to the network system 100. In an example, as long as the mechanical connector 125 is plugged in the host connector 115, the processor module 122 keeps executing the instruction codes of the service, and keeps providing the service in the network system 100.

According to an aspect of the disclosure, in an embodiment, via suitable communication within the network system 100, the dongle device 120 obtains an independent Internet protocol (IP) address, joins the network system 100 as an independent node, and provides the service to the network system 100 as an independent computer.

It is noted that the dongle device 120 can be suitably configured to provide various services to the network system 100. Such services include, but not limited to, cloud backup, antivirus, network accelerator, JAVA application, home automation, network attached storage (NAS), movie or video rental, voice over internet protocol (VoIP) service, media streaming/sharing service, packet processing and forwarding that supports previously unsupported protocols, intrusion monitoring, and the like. It is also noted that the dongle device 120 can operate as an independent computer to provide a service or can operate with the network device 110 to provide a service to the network system 100.

In an example, the dongle device 120 is sold with a preloaded antivirus software package. When the dangle device 120 is plugged into the network device 110 as an always-on computer, the processor module 122 in the dongle device 120 executes the preloaded antivirus software package to provide antivirus protection to the LAN. It is noted that the dangle device 120 has processing power, thus, in an example, the dangle device 120 executes the preloaded antivirus software package to provide the antivirus protection to the LAN. It is also noted that, in an example, the antivirus protection of the dangle device 120 at the network device 110 is provided to the whole LAN instead of a single computer.

In another example, the cloud backup service provider sells the dangle device 120 with a preloaded cloud backup software package. Then, when the dongle device 120 is plugged into the network device 110, the processor module 122 executes the preloaded cloud backup software package to back up data in the LAN, such as data in the PC 131.

In another example, the dangle device 120 is preloaded or loaded from the PC 131 with Java applications. The processor module 122 executes the Java applications to add service to the network device 110.

In another embodiment, the dongle device 120 is configured to provide network-attached storage (NAS) service. In an example, the dongle device 120 includes a receptacle interface, such as a USB receptacle, an external serial advanced technology attachment (eSATA) receptacle, and the like, that couples a storage, such as an external powered hard disk drive 126 with the dongle device 120. The dongle device 120 includes suitable software package. The processor module 122 executes the suitable software, such that the external powered hard disc drive provides storage space for other devices, such as the PC 131, in the LAN.

In another embodiment, the dongle device 120 is configured as a home automation router or coordinator to provide home automation service. In an example, the dongle device 120 includes a wireless communication module 124 that is configured according to a zigbee standard, for example. Further, the dongle device 120 includes suitable software. The processor module 122 executes the software to communicate according to zigbee standard. In addition, one or more appliances in the home are equipped with end zigbee devices. In an example, an air conditioner 127 uses a power plug to receive power from a power receptacle on the wall. The power plug includes an end zigbee device. The end zigbee device communicates with the dongle device 120 according to the zigbee standard. In addition, the end zigbee device monitors a room temperature, provides the monitored room temperature to the dangle device 120, receives control signals from the dongle device 120, and controls power supply to the air conditioner 127 based on the control signal. During operation, a user in the network 101 uses any suitable terminal devices, such as a computer, cell phone, and the like, to communicate with the dongle device 120 that is the home automation coordinator. Via the dongle device 120, the user observes the room temperature, and controls the operation of the air conditioner 127.

In another embodiment, the dongle device 120 is configured to accelerate the network device 110. In an example, a data stream corresponding to high-definition video is transmitted from the network 101 to the HDTV 133. It is noted that, in an example, the network 101 transmits the data stream using packets transmission. The packet transmission of the data stream causes jumping bit rate that harms video quality. When the network device 110 does not have enough resources to cache the packets of the data stream, the video image is choppy. The dongle device 120 has additional processing power and storage. The dongle device 120 suitably takes caching load for the data stream from the network device 110, and improves video quality.

In another embodiment, the dongle device 120 is configured to process packets. In an example, the network device 110 does not have support for a protocol that at least one of the home networking devices uses for communication. The dongle device 120 is configured to process packets and forward packets according to the protocol. In another embodiment, the dangle device 120 is configured to process packets and monitor intrusions.

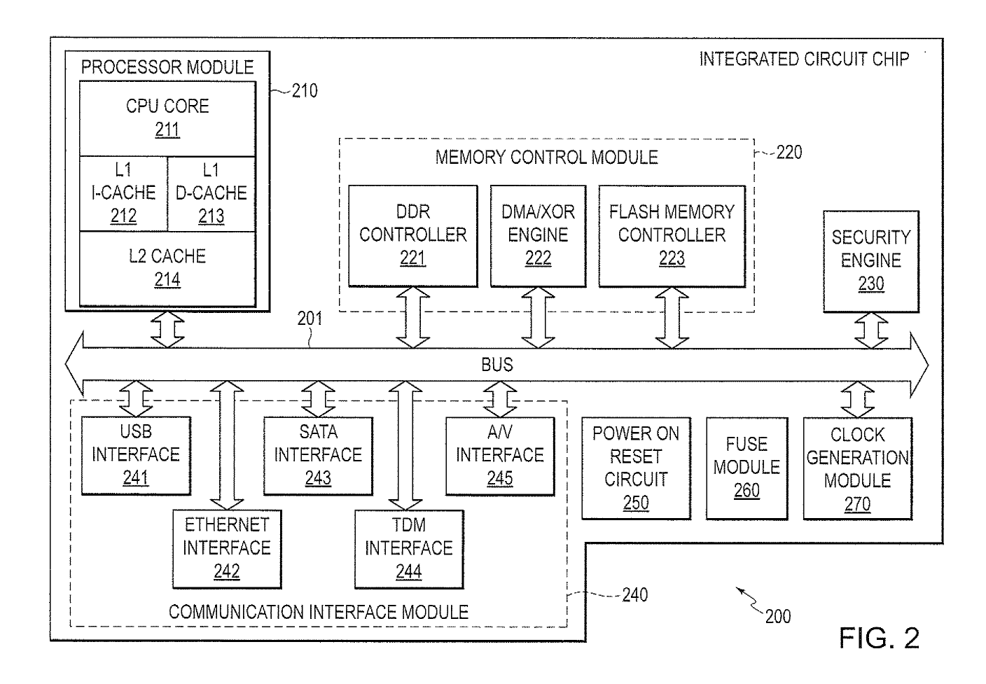

FIG. 2 shows a block diagram of an integrated circuit (IC) chip example 200 according to an embodiment of the disclosure. The IC chip 200 can be used in a dangle device, such as the dongle device 120. In the FIG. 2 example, the IC chip 200 includes a bus 201, a processor module 210, a memory controller module 220, a security engine 230, a communication interface module 240, a power-on-reset circuit 250, a fuse module 260, and a clock generation module 270. These elements are coupled together as shown in FIG. 2.

In an embodiment, the processor module 210 executes system and application codes, and performs data calculations. In the FIG. 2 example, the processor module 210 is configured using two levels of caches. Specifically, the processor module 210 includes a central processing unit (CPU) core 211, L1 caches including L1 instruction-cache 212 and L1 data-cache 213, and L2 cache 214. The CPU core 211 and the L1 caches 212-213 are closely integrated for fast accessing. The L2 cache 214 acts as an intermediary between a main memory and the L1 caches 212-213, and can store a much larger amount of information than the L1 caches 212-213, but at a longer access penalty. It is noted that the processor module 210 can use any other suitable architecture. It is also noted that, in another embodiment, the processor module 210 is hard coded with hardware components for providing a service.

The memory control module 220 controls memory access to a main memory. In an embodiment, the memory controller module 220 is configured to support memory access to various types of memories. In the FIG. 2 example, the memory controller module 220 includes a double data rate (DDR) controller 221, a direct memory access and exclusive-OR (DMA/XOR) engine 222, and a flash memory controller 223. The DDR controller 221 is configured to control memory access to DDR memory, such as DDR synchronous dynamic random access memory (SDRAM), and the like. In an example, the DDR SDRAM is on the IC chip 200. In another example, the DDR SDRAM is external to the IC chip 200. The DMA/XOR is configured to control memory access to disk drives. The flash memory controller 223 is configured to control memory access to a suitable flash memory, such NAND flash memory, NOR flash memory, and the like. In an example, the flash memory is on the IC chip 200. In another example, the flash memory is external to the IC chip 200. It is noted that the memory controller module 220 can include any other control components for accessing suitable memory.

The security engine 230 provides on-chip hardware that can be configured to provide electronic security service. In an example, the security engine 230 includes advanced encryption standard (AES) engine, data encryption standard (DES) engine, and triple DES (3DES) engine. The security engine 230 can be suitably configured to perform encryption and decryption according to the AES standard, the DES standard or the 3DES standard. In another example, the security engine 230 includes message digest (MD) engine, and secure hash algorithm (SHA) engine. The security engine 230 can be suitably configured to perform authentication according to the MD algorithm and the SHA algorithm. It is noted that the security engine 230 can include any other suitable engines for performing suitable security services.

The communication interface module 240 is configured to support communication with various devices. In the FIG. 2 example, the communication interface module 220 includes a USB interface 241, an Ethernet interface 242, an SATA interface 243, a time division-multiplexing (TDM) interface 244, and an audio/video (A/V) interface 245.

The USB interface 241 seen in FIG. 2 includes electronic circuits and instruction codes for receiving and transmitting signals according to the USB standard. In an example, the dongle device includes one or more USB connectors. The USB connectors are coupled with the USB interface 241. When a USB connector is used to couple another device with the dongle device, the USB interface 241 enables the dongle device to communicate with the other device using the USB standard.

The Ethernet interface 242 includes electronic circuits and instruction codes for receiving and transmitting signals using the Ethernet standard. In an example, the dongle device includes one or more Ethernet connectors. The Ethernet connectors are coupled with the Ethernet interface 242. When an Ethernet connector is used to couple another device with the dongle device, the Ethernet interface 242 enables the dongle device to communicate with the other device using the Ethernet standard.

The SATA interface 243 includes electronic circuits and instruction codes for receiving and transmitting signals using SATA standard. In an example, the dongle device includes one or more SATA connectors. The SATA connectors are coupled with the SATA interface 243. When an SATA connector is used to couple another device with the dangle device, the SATA interface 243 enables the dongle device to communicate with the other device using the SATA standard.

The TDM interface 244 includes electronic circuits and instruction codes for receiving and transmitting signals according to the TDM standard. In an example, the TDM interface 244 includes a foreign exchange station (FXS) portion and a foreign exchange office (FX) portion according to a telephone communication standard. The dongle device includes one or more telephone plugs. The telephone plugs are coupled with the TDM interface 244. When a telephone plug is used to connect a telephone with the dongle device, the TDM interface 244 enables telephone services using the telephone.

The A/V interface 245 includes circuit components and instruction codes for receiving and transmitting signals according to suitable audio and video standard. In an example, the A/V interface 245 includes a Sony Philips digital interface (SPDIF) portion, an integrated inter-chip Sound (12S) portion and a moving picture experts group transport stream (MPEG-TS) portion. In an example, the dongle device includes A/V connectors. The A/V connectors are coupled with the A/V interface 245. When an A/V connector is used to couple an A/V device with the dongle device, the A/V interface 245 enables the dongle device to provide video and audio signals to the A/V device.

It is noted that the communication interface module 240 can include any other suitable interfaces to support communication with various devices.

The power-on-reset circuit 250 resets the IC chip 200 into a pre-determined start state when it is powered on. In an example, from the pre-determined start state, the processor module 210 executes a routine procedure to initialize the dangle device, and then executes the instruction codes of a service to provide the service in a network.

The fuse module 260 includes fuses that are used to reconfigure the IC chip 200. In an embodiment, the fuse module 260 includes electronic fuses (e-Fuses) that can be blown electronically. In an example, the IC chip 200 includes redundant elements. A redundant element can be used to replace a defective element by suitably blowing the e-Fuses.

The clock generation module 270 includes suitable components to generate and provide necessary clock signals for the operation of the IC chip 200.

It is noted that, while in the FIG. 2 example, the bus 201 is used to couple the various elements, the IC chip 200 can be suitably modified to use any other architecture. It is also noted that the IC chip 200 can be suitably modified as a chipset that includes multiple chips.

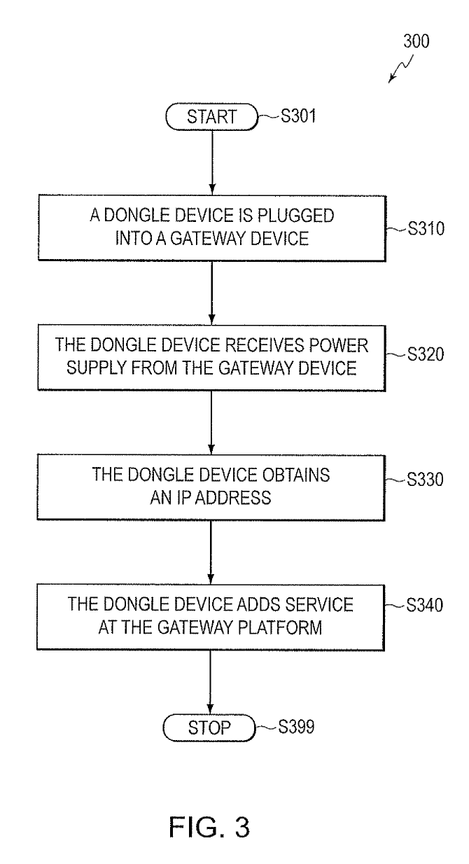

FIG. 3 shows a flowchart outlining a process example for using a dongle device, such as the dongle device 120, according to an embodiment of the disclosure. The dongle device includes a processor module having processing power. In addition, the dongle device includes instruction codes of a service. The process starts at S301 and proceeds to S310.

At S310, the dongle device is plugged into a network device, such as the gateway device 110 in FIG. 1 configured as a residential gateway device that couples an LAN with a larger network. The gateway device includes a host connector, such as a USB host connector, having power pins and data pins. The dangle device includes a connector, such as a USB connector, that is compatible with the host connector, and has corresponding power pins and data pins. When the connector of the dongle device is plugged into the host connector of the gateway device, the power pins of the dongle device are respectively coupled to the power pins of the gateway device, and the data pins of the dongle device are respectively coupled to the data pins of the gateway device.

At S320, the dangle device receives power supply from the gateway device. In an example, the dongle device includes an IC chip having power pins. The power pins of the connector are suitable coupled to the power pins of the IC chip, and direct power supply to the IC chip. In an embodiment, the IC chip includes a power-on reset circuit that resets the IC chip into a predetermined start state. From the predetermined start state, a processor module on the IC chip starts executing instruction codes. In an example, the dangle device is configured as a plug-and-play device. From the predetermined start state, the processor module automatically starts executing a routine of instruction codes.

At S330, the dongle device has its own independent processing capabilities and obtains an independent IP address. In an embodiment, the dongle device includes instruction codes to communicate with the gateway device or any other devices in the LAN to suitably obtain the independent IP address. It is noted that this step is optional. In an embodiment, the dangle device does not need to obtain an independent IP address.

At S340, the dongle device executes the instruction codes of the service to add service to the LAN at the gateway platform. It is noted that, in an example, the service is hard coded in the hardware of the dongle device, thus, the dongle device operates according to the hardware to provide the service. Then the process proceeds to S399 and terminates.

It is noted that the process 300 can be suitably modified. In an example, the dongle device skips S330, and operates with the gateway device. In another example, the dongle device provides NAS service. The dongle device executes additional steps, such as checking interfaces, waiting for a mass storage device being plugged in, and the like. In another example, the process includes additional steps for a user to check a version of the instruction codes on the dongle device, and to load newer version of the instruction codes to update the service.

It is noted that the dongle device can be plugged into other suitable network device that may not be a gateway device to provide a service to a network.

While the invention has been described in conjunction with the specific embodiments thereof that are proposed as examples, it is evident that many alternatives, modifications, and variations will be apparent to those skilled in the art. Accordingly, embodiments of the invention as set forth herein are intended to be illustrative, not limiting. There are changes that may be made without departing from the scope of the invention.

What is claimed is:

1. A dongle device, comprising:
a connector configured to connect the dongle device to a network device that performs packet switching in and out of a network and within the network, the connector having a power pin configured to receive a power supply from the network device to power up the dongle device, and a data pin configured to enable the dongle device to communicate with the network device; and
a processor configured to provide a service in the network after the dongle device is powered up.

2. The dongle device of claim 1, wherein
the processor is configured to obtain an independent Internet protocol (IP) address to operate as an independent node in the network.

3. The dongle device of claim 1, wherein
the connector is configured to connect the dongle device to a residential gateway device that couples a local area network (LAN) to another network; and
the processor is configured to execute instruction codes of the service, and provide the service to the LAN.

4. The dongle device of claim 1, wherein:
the connector is configured according to at least one of a universal serial bus (USB) and IEEE 1394.

5. The dongle device of claim 1, further comprising:
a memory configured to store at least the instruction codes of the service.

6. The dongle device of claim 5, wherein
a memory chip includes the memory; and
a system-on-chip includes the processor.

7. The dongle device of claim 1, wherein:
the processor is configured to provide at least one of a cloud backup service, an antivirus service, an Internet accelerator service, a JAVA application service, a home automation service, a voice-over-internet-protocol (VOIP) service, a packet forwarding service, an intrusion monitor service, and a network attached storage (NAS) service.

8. The dongle device of claim 1, further comprising:
a wireless transceiver configured to receive and transmit wireless signals.

9. An electronic system, comprising:
a network device configured to perform packet switching in and out of a network and within the network; and
a dongle device comprising:
a connector configured to connect the dongle device to the network device, the connector having a power pin configured to receive a power supply from the network device to power up the dongle device, and a data pin configured to enable the dongle device to communicate with the network device; and
a processor configured to provide a service in the network after the dongle device is powered up.

10. The electronic system of claim 9, wherein
the processor is configured to obtain an independent Internet protocol (IP) address to operate as an independent node in the network.

11. The electronic system of claim 9, wherein
the network device is configured as a residential gateway device that couples a local area network (LAN) to another network;
the connector is configured to connect the dongle device to the residential gateway device; and
the processor is configured to provide the service to the LAN.

12. The electronic system of claim 9, wherein:
the connector is configured according to at least one of a universal serial bus (USB) and IEEE 1394.

13. The electronic system of claim 9, wherein the dongle device further comprises:
a memory configured to store instruction codes of the service.

14. The electronic system of claim 13, wherein the dongle device comprises:
a memory chip that includes the memory; and
a system-on-chip that includes the processor.

15. The electronic system of claim 9, wherein:
the processor is configured to provide at least one of a cloud backup service, an antivirus service, an Internet accelerator service, a JAVA application service, a home automation service, a voice-over-internet-protocol (VOIP) service, and a network attached storage service.

16. The electronic system of claim 9, wherein the dongle device further comprises:
a wireless transceiver configured to receive and transmit wireless signals.

17. A method for upgrading a network device, comprising:
coupling a dongle device including a packet processor and a memory to a port of the network device; and
processing packets received at the network device using the dongle device.

18. The method of claim 17, wherein coupling the dongle device including the packet processor and the memory to the port of the network device further comprises:
coupling the dongle device to at least one of a universal serial bus (USB) port and an IEEE 1394 port of the network device.

19. The method of claim 17, further comprising:
obtaining an independent Internet protocol (IP) address for the dongle device to operate as an independent node in the network.

20. The method of claim 17, further comprising:
processing the packets received at the network device according to instruction codes in the memory of the dongle device.
